(19) United States
(12) Patent Application Publication
(10) Pub. No.: US 2015/0319256 A1
(43) Pub. Date: Nov. 5, 2015

(54) IMPLICIT RELATIONSHIP DISCOVERY BASED ON NETWORK ACTIVITY PROFILE SIMILARITIES

(71) Applicant: Glimmerglass Networks, Inc., Hayward, CA (US)

(72) Inventor: Tim L. Casey, San Jose, CA (US)

(21) Appl. No.: 14/703,453

(22) Filed: May 4, 2015

Related U.S. Application Data
(60) Provisional application No. 61/988,777, filed on May 5, 2014.

(51) Int. Cl. H04L 29/08; G06Q 50/26; G06Q 50/00

(52) U.S. Cl. CPC H04L 67/22; G06Q 50/01; G06Q 50/26

(57) ABSTRACT

An extent of relatedness between entities that might exhibit no express relationship is determined based on network communications with shared endpoints. Communications occurring in a network are monitored. For each particular endpoint in the network, a set of other endpoints with which that particular endpoint has communicated is determined based on the monitored communications. For each pair of endpoints in the network, the intersection of the sets determined for those endpoints is determined to be the set of shared endpoints for that pair. The endpoints in the set of shared endpoints can be inversely weighted based on their overall popularity among all of the network's endpoints. The weights of the shared endpoints in the pair's set of shared endpoints can then be multiplied together to produce a relatedness score for that pair of endpoints.

### CROSS-REFERENCES TO RELATED APPLICATIONS

The present application is related to U.S. Provisional Patent Application Ser. No. 61/948,476, filed on Mar. 5, 2014, titled “IMPLICIT RELATIONSHIP DISCOVERY BASED ON CUMULATIVE CO-TEMPORAL ACTIVITY.”

The present application claims benefit under 35 USC 119(e) of U.S. provisional Application No. 61/988,777, filed on May 5, 2014, entitled “IMPLICIT RELATIONSHIP DISCOVERY BASED ON NETWORK ACTIVITY PROFILE SIMILARITIES,” the content of which is incorporated herein by reference in its entirety.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

Embodiments of the invention pertain to the field of data analysis generally, and more specifically to the automated discovery of implied relationships between entities based on network communications. In investigative endeavors, such those often occurring in law enforcement or other security fields, it is often helpful to determine relationships between entities. Such entities might be people, for example. If one person is a suspect in a crime, then determining other people who are related to that person in some way might help investigators to obtain more information about the crime or the suspected person. Such other people might be able to provide that information if questioned. Such other people might themselves be involved in the crime. Sometimes, relationships are express. For example, if a man has a brother, then that man and his brother are involved in an express familial relationship. If a man works in the same office as another man, then those man are involved in an express employment-based relationship.

Those who are involved in crimes or other misbehavior often actively seek to conceal their relationships to others who might be able to provide information about them or their activities. Two or more people who conspire to commit a crime, such as an act of terrorism, for example, might not have any express relationship that is easily determinable. Co-conspirators might never meet with or communicate directly with each other. Co-conspirators might not even know each other's identities in some cases. Under such circumstances, investigators might be hampered by a lack of express relationships on which to base their investigative efforts. What is needed therefore are mechanisms to identify and exploit implicit relationships.

### SUMMARY OF THE INVENTION

According to the invention, implicit relationships are identified by using a data processing system having access to a communication network to develop and compare network activity profiles. Disclosed herein are techniques for discovering implied relationships between entities that are active in communication networks such as online social networks. Such entities may be endpoints within a network, for example. Each endpoint can be characterized by a different Internet Protocol (IP) address. Based on the extent of overlap between sets of shared endpoints with which a given pair of endpoints communicates during a time interval, a probability or extent of relatedness between the endpoints in that pair can be determined and upon that basis a decision can be made about the existence of a relevant relationship. Such a probability or extent of relatedness can be used for a variety of purposes. For example, in a law enforcement context, if a machine associated with a first endpoint is misbehaving, then the a high probability or extent of relatedness between the first endpoint and a second endpoint can give investigators cause to pursue the investigation of a machine associated with the second endpoint as well. The discovery of relatedness between two endpoints that might otherwise have no formal express relationship or direct intercommunication can be useful in combatting terrorism, for example.

According to a technique disclosed herein, communications occurring in a network are monitored by data processing apparatus in each time interval of a series of time intervals. For example, the communications can be monitored by a group of routers, switches, hubs, or other electronic network elements residing in the network of interest. For each particular endpoint in the network, a set of other endpoints with which that particular endpoint has communicated during the current time interval is determined based on the monitored communications. For each pair of endpoints in the network, the intersection of the sets determined for those endpoints for the current time period can be determined. The intersection thus constitutes the set of shared endpoints for that pair for the current time interval.

The endpoints in the set of shared endpoints can be inversely weighted based on their overall popularity among all of the network's endpoints during the current time interval. In this manner, shared endpoints that are highly popular (and therefore less meaningful in determining unusual similarities in network communications) during a given time interval can be given a reduced influence on the relatedness conclusions reached during that time interval. The weights of the shared endpoints in the pair's set of shared endpoints can then be multiplied together to produce a relatedness score for that pair of endpoints for that current time interval.

Over time, as shared endpoint popularity evolves and sets of shared endpoints for a particular endpoint pair evolve, the relatedness scores calculated for the particular endpoint pair for each of the time intervals can be accumulated in order to estimate an overall probability or extent of relatedness for that particular endpoint pair. Such an estimation can be performed for each pair of endpoints in the network.

The invention will be better understood upon reference to the following detailed description of specific embodiments as illustrated by the accompanying figures.

### BRIEF DESCRIPTION OF THE DRAWINGS

FIG. 1 is a flow diagram that illustrates an example of a technique for determining the relatedness of a pair of endpoints based on other endpoints with which both of the endpoints in the pair communicate, according to an embodiment of the invention.

FIG. 2 is a flow diagram that illustrates an example of a technique for determining the relatedness of a pair of endpoints based on other endpoints with which both of the endpoints in the pair communicate, according to an embodiment of the invention.

FIG. 3 is a flow diagram that illustrates a technique for determining an extent of relatedness between pairs of endpoints in a network, according to an embodiment of the invention.

FIG. 4A is a simplified block diagram of an implementation of a device according to an embodiment of the present invention.

FIG. 4B is a simplified block diagram of an implementation of a server according to an embodiment of the present invention.

FIG. 5 is a block diagram of a communication network comprising elements employed in accordance with the invention.

### DETAILED DESCRIPTION OF THE INVENTION

Techniques disclosed herein are particularly useful for determining, automatically, whether two entities indirectly communicate with each other through a network, such as the Internet. These indirect communications can be used to imply relationships between the communicators that are not otherwise obvious. The entities can be people. The network can be large, with a complex topology. The entities can be connected with each other in a variety of ways. The entities might be connected with each other through one or more shared connections. Commonly, a pair of entities will have multiple shared connections.

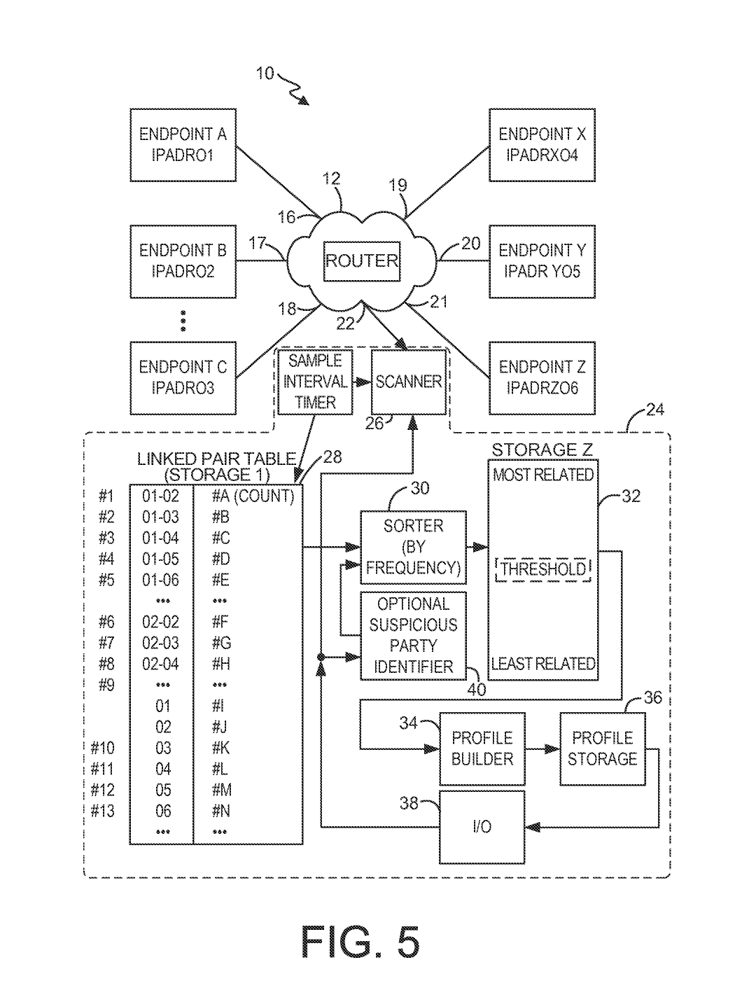

FIG. 5 illustrates a system incorporating functions according to the invention. The illustrative system 10 is built around a communication cloud 12 containing at least one router 14 and a plurality of real or virtual ports 16-21 with at least one port 22 coupled to the monitoring and analysis machine 24 according to the invention having at least one scanner component 26. The scanner component 26 may scan IP addresses to monitor the input and output traffic, or it may scan social media websites such as LinkedIn, GooglePlus, Facebook, Twitter, Instagram or the like, whether public or private and scan friends lists for relationships. Postulated links between endpoints or parties that are being monitored are catalogued in a linked pair table 28 (“Storage 1”). The pairs may represent direct links between two endpoints or links with an intermediate “endpoint” such as a commonly shared social media website as herein after explained. A sample time interval is set by a sample interval timer 30. The number of activities of an endpoint communicating with another endpoint or otherwise conveying information via its communication medium during the sample time interval is captured and stored at a location associated with the endpoint or party in the linked pair table 28. If it can be confirmed that one endpoint is associated with another monitored endpoint, its activity designator is stored in a linked pair location. The message direction (send and receive) may or may not be catalogued. The numbers of activities in the table 28 are sorted (each time interval) by a sorter 30 and stored in a corresponding memory (Storage 2) 32 for the selected time interval. The values for the time intervals may be stored separately or the time intervals integrated over longer time periods and sorted upon for long-term analyses and used to build a profile. For this purpose a profile build component 34 reads data from storage 2 32 and compiles profiles in profile storage 36 for each endpoint or party. The profiles are retrieved by an output component or I/O component 38. Parameters for selecting types of profiles or selecting endpoints or parties to be monitored are established by an input component such as the I/O component 38. It may also control the scanner 26 and an optional suspicious party identifier 40. These components can be assembled from generally available computational and electronic equipment adapted for the specified functions as hereinafter explained in greater detail.

An example of a process according to the invention follows to illustrate the invention. For example, one person might have a shared connection with another person, professionally, in the form of a relationship on LinkedIn; the people might both have LinkedIn accounts that they have elected to associate with each other. However, even if the people have not elected to establish a formal association on a particular website, the mere fact that those people both communicate with the same website may constitute some evidence of the existence of an implied, rather than express, relationship between those people. As the quantity of such shared connections between a pair of entities increases, the likelihood that those entities are actually related to each other in some capacity, and the extent to which they are related to each other in some capacity, increases.

### Shared Endpoints and Conceptual Links

Entities can be imagined as endpoints with a telecommunication network. The boundaries of the network can be defined as desired. For example, the network can be defined more restrictively as a business enterprise's local area network. For another example, the network could be as broad as the entire Internet. Each endpoint can be associated with a separate Internet Protocol (IP) address. Servers or sites with which those entities communicate through the network can be imagined as other endpoints within the network. When one endpoint communicates with another endpoint through the network, a conceptual link is formed between those endpoints. When a pair of endpoints both have formed a link to another endpoint in this manner, that other endpoint is considered to be a shared endpoint for the pair. For example, a pair of endpoints might mutually share other endpoints such as Facebook, LinkedIn, a particular employer's website, etc. Such shared endpoints also can be called “common nodes” relative to the pair sharing those endpoints.

Endpoints can be shared even if no further formal relationship at those endpoints is ever created between the pair sharing those endpoints. For example, a pair of endpoints can share a Facebook or LinkedIn endpoint simply by virtue of the fact that each endpoint in that pair communicates with Facebook or LinkedIn, even if the people who correspond to the endpoints in the pair have not elected to be friends or connections within those social media sites.

### Similarities in Usage of Network Topologies

A network has a topology that can be represented as a graph including nodes and edges. A topology is a directed, acyclic proper sub-graph. For example, a network might have a star topology in which all nodes in the graph other than a “hub” node are directly connected by edges to that hub node. A pair of endpoints might both be members of multiple separate network topologies. In one embodiment, the quantity of separate network topologies to which a pair of endpoints belong is counted. The quantity of such separate network topologies to which both endpoints in the pair belong is indicative of the extent of relatedness of the endpoints in that pair. A topology can be any path between two endpoints connecting through the network in a non-cyclic manner.

For example, if a network included nodes A, B, C, and C, then paths A->B->C->D and D->C->B->A would each be four node, three link paths between A and D. A topology is not necessarily limited to a set of endpoints which had communication. In the preceding example, A does not need to communicate with C, but each link along the way is involved in communication. A simpler path, which makes sense in a modern networked world, might be path A->B->C, in which node A communicates with node C through a server node B. In this pattern, server node B can be a shared endpoint, and might represent a server offering services such as those offered by LinkedIn, Facebook, or Google, for example. In this example, nodes A and C would be the consumers of those services. A single template path can be applied to all possible paths within a graph to find a likelihood that two endpoints are related.

Entities that are related to each other may engage each other in communications that are difficult to detect because these communications might be indirect or conducted through unconventional channels. Such communications may be “out of band” communications, in that these communications, often containing the information of the most interest, might not be conducted over the same channels as less interesting communications between the entities. Out of band communications between entities can be conducted using an covert agreement between those entities.

For example, the entities might agree on a protocol in which one entity will deposit, in a predetermined location in a network, information that another entity can later retrieve and use to ascertain the proper, possibly encoded context of more overt communications occurring between those entities. Techniques disclosed herein are useful for discovering such communications in order to predict relationships between entities that otherwise might remain undiscovered.

Using techniques disclosed herein, commonalities in communications conducted by pairs of entities can be detected automatically. The significance of these commonalities can be placed in context of other communications occurring within the same network. Commonalities that are significant enough to be distinguished from normal communications occurring within the same network can be used to conclude that a relationship exists between entities. Such a relationship might exist by virtue of covert agreements or out-of-band communications that occur between implicitly paired endpoints and other shared endpoints with which the implicitly shared endpoints both communicate, even if the implicitly paired endpoints rarely or never directly communicate with each other.

### Monitoring Attributes of Network Usage to Discover Similarities

Entities, and the endpoints that represent those entities, may use a network in approximately or exactly the same manner. Endpoints that use a network in such a manner, such as by communicating with approximately the same sets of endpoints in those networks, are more likely to be related to each other than other endpoints that use that network in a less similar manner. By monitoring network communications over time, similarities in endpoints' use of a network can be detected. Relationships can be implied based on such detected similarities.

For example, communications flowing through a network might reveal not only that particular endpoints in a pair both tend to communicate frequently with the same set of shared endpoints, but also that those particular endpoints both tend to use the same applications served by those endpoints. Communications might reveal that the particular endpoints tend to perform the same types of activities relative to the same set of endpoints. Under such circumstances, the likelihood of an existence of an implicit relation between the particular endpoints may be relatively high. Various attributes of endpoints' network usage can be monitored and analyzed to discover similarities between those endpoints' usage.

### Interpreting Network Usage in Overall Context

Although both endpoints in a pair of endpoints might communicate with many of the same shared endpoints in a network, this fact alone might not imply a significant relationship between the endpoints in that pair. Some shared endpoints in a network might be accessed by such a large proportion of all of the network's users that common use of those shared endpoints by any two users is relatively meaningless for the purpose of discovering implied relationships.

For example, the fact that a pair of endpoints both frequently communicate with Facebook (a popularly utilized shared endpoint in the Internet) might not be sufficient to imply a relationship between those endpoints because a very high percentage of endpoints in the network also frequently communicate with Facebook; such network activity is normal and perhaps even expected. In contrast, two endpoints' frequent communication with a set of shared endpoints that are very infrequently used by other endpoints in the network may strongly suggest that those two endpoints are highly related to each other.

Thus, if a relatively small group of endpoints all tend to access an extremist website that advocates violence against others, while other endpoints in the network have no association whatsoever with that website, this fact tends to imply that the endpoints in the small group are related to each other. Relationships between those endpoints are even more strongly implied as the quantity of such relatively unpopular websites commonly accessed by endpoints in that group increases.

### Non-Binary Degrees of Relatedness

Discussed above are general indicators that pairs of endpoints, and the entities that they represent, may be implicitly related. However, in an embodiment, the existence of absence of an implied relationship between a pair of endpoints is not necessarily a strictly binary concept. Instead of determining that two endpoints definitely are or are not related to each other, techniques discussed herein can assign, to each pair of endpoints in a network, a score that is indicative of how related to each other that pair of endpoints probably is. Each pair of endpoints in a network can be assigned a relationship strength that is based on the communications of those endpoints with similar sets of other shared endpoints.

### Shared Endpoint Popularity Threshold for Meaningfulness

According to an embodiment, a threshold can be established whereby communications with highly popular endpoints are disregarded for the purpose of implying relationships between entities. The threshold can be a percentage of total network endpoints that communicate with a particular shared endpoint over a specified time interval. If the percentage for a particular shared endpoint exceeds the threshold, then communications involving that particular shared endpoint can be ignored when analyzing network communications to measure relatedness. For example, if analysis of network communications over a month reveals that 85% of endpoints from which at least one communication was noticed that month were involved in at least one communication with Facebook that month, and if the threshold is 70% of endpoints per month, then all communications with Facebook that month can be ignored for relationship implication purposes.

However, it is possible that shared endpoints that are popular during one time interval might be less popular during other time intervals. Monitored communications with a shared endpoint that formerly were not very useful in determining endpoint relatedness, because of that shared endpoint's formerly near-universal usage among a network's other endpoints, can later become more useful if that shared endpoint's popularity wanes.

Therefore, in one embodiment of the invention, the popularity of each shared endpoint, measured as a proportion of total network endpoints that accessed that shared endpoint at least once during a time interval, is measured separately for each subsequent time interval in a series of time intervals. Evaluation of each shared endpoint against the threshold can be conducted independently in each separate time interval. Even if communications with a particular shared endpoint during one time interval were disregarded due to the excessive popularity of the particular endpoint during that time interval, communications with that same particular shared endpoint occurring during another time interval may be used in implied relatedness determinations if the popularity of the particular shared endpoint did not exceed the threshold during that other time interval.

The application of the threshold discussed above to communications with shared endpoints can be thought of as a “scaling factor” which places shared endpoint communications in their proper context relative to all of the communications in a network. Communications with unpopular shared endpoints are more meaningful, when implying relationships, than are communications with popular shared endpoints. If not for the application of this scaling factor, then communications with less popular shared endpoints might become lost within the noise of communications with very popular shared endpoints.

### Relatedness Score

As is discussed above, similarities in network topologies can be used in order to determine a degree of relatedness. In one embodiment, all of the other endpoints with which a first endpoint communicates in a network are considered to form a first network topology. All of the other endpoints with which a second endpoint communicates in a network are considered to form a second network topology. The extent to which the first network topology and the second network topology overlap is indicative of the relatedness of the first endpoint to the second endpoints.

In one embodiment, for a specified time interval, each endpoint in a network is assigned a node weight that is based on the overall popularity of that endpoint during that specified time interval. The overall popularity of a particular endpoint can be calculated by dividing (a) the quantity of a network's endpoints that engaged in at least one communication with that particular endpoint by (b) the quantity of the network's endpoints from which at least one communication with any endpoint was detected during the specified time interval. Other measures of overall popularity may be used instead. In one embodiment, each endpoint's node weight for a specified time interval is equal to the reciprocal of that endpoint's overall popularity for the specified time interval—one divided by that endpoint's overall popularity. Thus, the less popular a particular endpoint is during a particular time interval, the greater that particular endpoint's node weight will be for that particular time interval.

In one embodiment, for each pair of endpoints in a network, the set of shared endpoints in the overlapping topologies of the endpoints in that pair are determined for a specified time interval. The node weights of these shared endpoints in this set are then multiplied with each other to produce the relatedness score for the endpoints in that pair for that specified time interval.

### Evolution Over Time

As is discussed above, over time, the popularity of shared endpoints, and therefore their node weights, can change. The network topologies of various endpoints in the network also can change over time, as can the extent of overlap between pairs of those topologies. Therefore, in one embodiment of the invention, in each subsequent time interval, and for each pair of endpoints in a network, the newly calculated relatedness score for that pair of endpoints in the most recent time interval is added to a running total relatedness score for those endpoints. This running total relatedness score may be more representative of a lasting implied relationship between a pair of endpoints. Anomalies arising during any single time interval will gradually lose influence on the running total relatedness score.

The running total relatedness score can be divided by the total quantity of time intervals in which relatedness scores have been calculated, in order to obtain an average total relatedness score per time interval. In one embodiment, prior to adding the most recent time interval's relatedness score to the running total relatedness score for a pair of endpoints, the running total relatedness score is first multiplied by some specified factor less than one, in order to cause more recent communication events to have greater influence on total relatedness than much less recent communication event have.

### Relatedness Ranking

After relatedness rankings have been computed for each pair of endpoints, either for a particular time interval or for a whole series of time intervals, the pairs of endpoints can be ranked relative to each other based on their relatedness scores pertaining to the time period at issue. A computing system 24 as in FIG. 5 can receive, from its scanner 26, user input that specifies one or more time intervals for which the rankings are to be computed. For each pair of endpoints in the network, the computing system 24 can total the relatedness scores for that pair over all of the specified time intervals.

The computational elements such as the sorter 30 of the computing system 24 can place the endpoint pairs having the highest relatedness totals toward the top of the ranked list and be stored in in the memory component 32. The remaining endpoint pairs can follow and be stored in descending order of relatedness totals. For each endpoint pair in the ranked list, the computing system 24 can display, print, or store both the identities of the entities to which the endpoints in the pair correspond (e.g., names, street addresses, IP addresses, etc.) and the relatedness total for that pair through the I/O component 38. Additionally, for each endpoint pair in the ranked list, the computing system 24 can display, print, or store a list of the shared endpoints that contributed to that endpoint pair's relatedness total. The computing system 24 can display, print, or store each such shared endpoint's corresponding node weights for the time intervals used in the report generation. The data may be presented in raw format or as part of a profile compiled by the profile build component 34.

In this manner, a user can view the endpoints (and corresponding entities) that are most related to each other of all of the endpoints in a network, relative to other endpoints in the same network.

### Relatedness Spike Alarms

In one embodiment of the invention, the computing system 24 can continuously monitor the relatedness of endpoints in real-time. The computing system 24 can monitor network communications as those communications occur, and can re-evaluate the relatedness of endpoints in the network based on those recent communications. For each set of related endpoints having a relatedness score that currently exceeds a specified threshold, the computing system 24 can designate those endpoints as being, at least currently, strongly related.

According to one technique, for each particular endpoint that is shared by at least one pair of strongly related endpoints, the computing system 24 can maintain a set of strongly related endpoints that includes all endpoints that are strongly related to each other via at least that particular endpoint during the current time interval. Over time, the set of endpoints that are strongly related to each other via that particular endpoint can change. If the computing system 24 detects that the cardinality of that set of endpoints changes significantly (e.g., more than a specified threshold amount) between two time intervals, thereby indicating a sharp increase or decline in the constituency of the set of endpoints that are strongly related via the particular endpoint, then the computing system 24 can generate an alarm via the I/O component 38. The alarm can signal to a human user that a sharp increase or decline in relatedness through the particular endpoint has occurred, potentially warranting additional scrutiny or action by the human user.

### Example Flow for Shared Endpoint Relatedness Determination

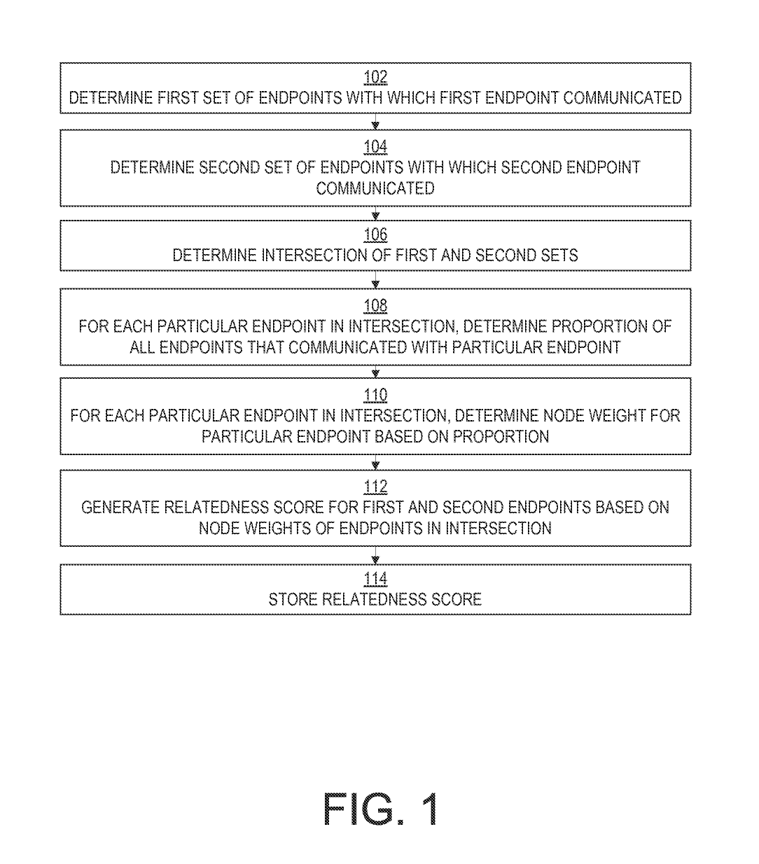

FIG. 1 is a flow diagram that illustrates an example of a technique for determining the relatedness of a pair of endpoints based on other endpoints with which both of the endpoints in the pair communicate, according to an embodiment of the invention. In one embodiment, the computer system 24 performs the technique based on analysis event data that has been recorded over some period of time, or that is currently being recorded or observed. Such event data can include, for example, HTTP messages, e-mail messages, telephone call records, text messages, or virtually any other kind of communication.

In block 102, a first set of endpoints with which a first endpoint communicated during a time interval is determined. In block 104, a second set of endpoints with which a second endpoint communicated during the time interval is determined. In block 106, an intersection of the first and second sets is determined.

In block 108, for each particular endpoint within the intersection, a proportion of all of the endpoints in the network that communicated with that particular endpoint during the time interval is determined. In block 110, for each particular endpoint within the intersection, a node weight for that particular endpoint is determined by calculating the reciprocal of the proportion determined for that particular endpoint in block 108.

In block 112, the node weights of the endpoints within the intersection are multiplied together to generate a relatedness score for the first and second endpoints during the time interval. In block 114, the relatedness score is stored on a computer-readable medium, such as storage 2 32.

### Relatedness Through Network Activity Profile Similarity

According to another technique described herein, each endpoint in a network is associated with a network activity profile that is based on the frequency with which that endpoint communicates with various other endpoints in the network. The network activity profiles of separate endpoints can be compared with each other: The more similar the network activity profiles of two endpoints, the greater the extent of their relatedness.

In an embodiment, network communications are monitored as by scanner 26 to determine how many times during a time interval a particular endpoint communicates with each other endpoint in a network. For example, a particular endpoint might communicate with endpoint A 50 times, with endpoint B 35 times, and with endpoint C 15 times during the time interval. A percentage of the particular endpoint's total quantity of communications that was involved with each other endpoint can be determined based on these totals.

In the above example, 50% of the particular endpoint's communications were with endpoint A, 35% of the particular endpoint's communications were with endpoint B, and 15% of the particular endpoint's communications were with endpoint C. The network activity profile of the particular endpoint for the time interval therefore would be 50% A, 35% B, and 15% C. A separate percentage-based network activity profile can be generated in like manner for each endpoint in the network, as for example by the profile build component 34. The rankings are inversely proportional to the commonality of the communication.

After a network activity profile has been generated for each endpoint, the other endpoints in each network activity profile are ranked relative to each other based on their associated percentages, with the profile's endpoints having the highest associated percentages occurring at the top of the ranked list. Therefore, for example, the ranked list for the particular endpoint discussed above would be: A, B, C. Other endpoints might have different ranked lists.

It is possible that during the time interval no communications at all occurred between a pair of endpoints. If a particular endpoint did not communicate with another endpoint during a time interval, then that other endpoint is placed at the bottom of the particular endpoint's ranked list. For example, if the particular endpoint discussed above never communicated with endpoints D or E during the time interval, then endpoints D and E would be placed below A, B, and C in the particular endpoint's ranked list.

After a ranked list has been generated for each endpoint in the above manner, each endpoint's ranked list is compared to each other endpoint's ranked list to determine the similarities between those ranked lists. Such comparison can be performed using clustering techniques, for example. Additionally or alternatively, since every other endpoint appears in each ranked list, the distances in rank positions of those other endpoints between two ranked lists can be used to determine, in part, the extent of similarity of those two ranked lists.

Furthermore, endpoints in higher positions in each ranked list can be given greater weight or influence in determining similarity than endpoints in lower positions are given. Thus, if two ranked lists both have the same endpoint in the highest position, that may positively influence a determination of list similarity to a major extent, while if the two ranked lists both have the same endpoint in the lowest position, that may positively influence a determination of list similarity to a minor or negligible extent.

For any two endpoints in the network, then, the extent of relatedness of those two endpoints is, according to one technique, based on the extent of similarity between those endpoints' ranked lists. Two endpoints having very similar ranked lists will, under such an approach, be determined to have a relatively high extent of relatedness or probability of being related, while two endpoints having very dissimilar ranked lists will, under such an approach, be determined to have a relatively low extent of relatedness or probability of being related.

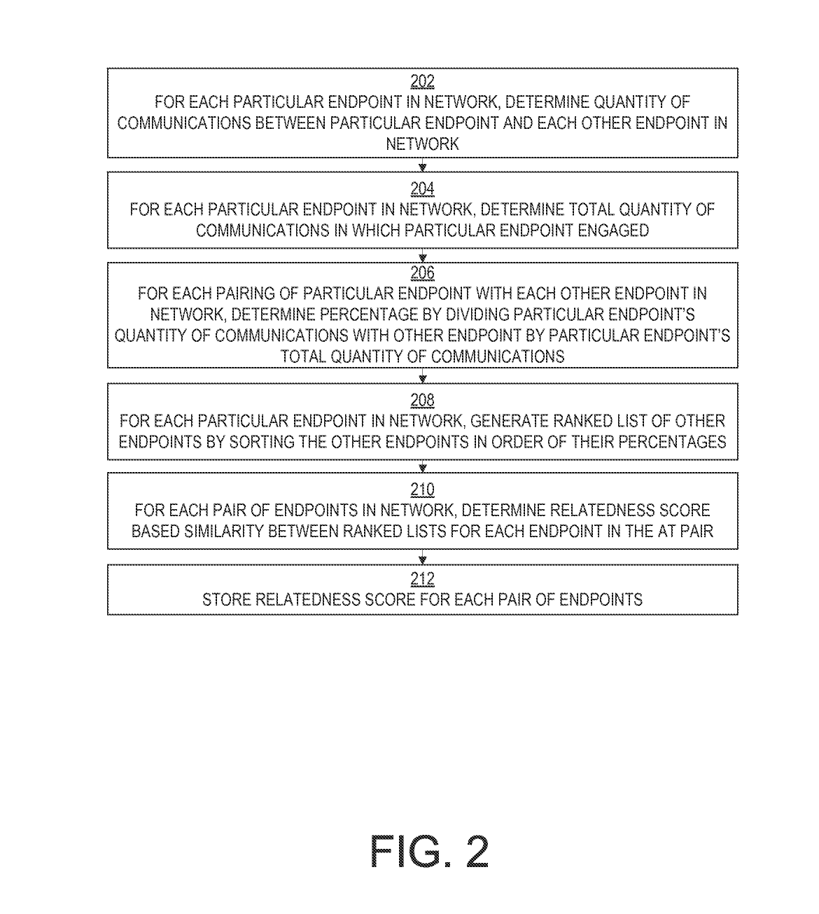

FIG. 2 is a flow diagram that illustrates an example of a technique for determining the relatedness of a pair of endpoints based on other endpoints with which both of the endpoints in the pair communicate, according to an embodiment of the invention. In one embodiment, the computer system 24 performs the technique based on analysis of event data that has been recorded over some period of time, or that is currently being recorded or observed. Such event data can include, for example, HTTP messages, e-mail messages, telephone call records, text messages, or virtually any other kind of communication.

In block 202, for each particular endpoint in a network, a quantity of communications that transpired between that particular endpoint and each other endpoint in the network during a time interval is determined. In block 204, for each particular endpoint in the network, a total quantity of communications in which that particular endpoint engaged during the time interval is determined. In block 206, for each pairing of the particular endpoint with each other endpoint in the network, a percentage associated with that other endpoint is determined by dividing the particular endpoint's quantity of communications with that other endpoint (determined in block 202) by the particular endpoint's total quantity of communications (determined in block 204).

In block 208, for each particular endpoint in the network, a ranked list of other endpoints is generated for that particular endpoint by sorting the other endpoints in order of their associated percentages (determined in block 206). In block 210, for each pair of endpoints in the network, a relatedness score is determined based on the similarity between the ranked lists generated (in block 208) for each endpoint in that pair. In block 212, the relatedness score for each pair of endpoints in the network is stored on a computer-readable medium.

### Coincidental Access

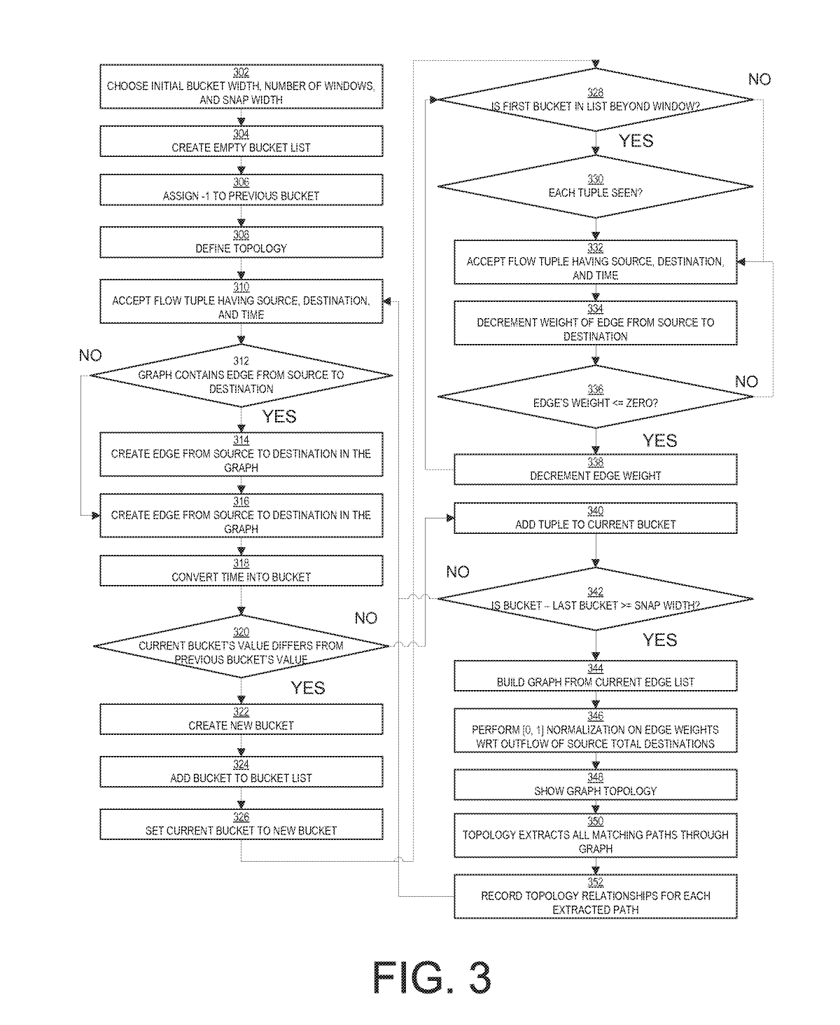

FIG. 3 is a flow diagram that illustrates a technique for determining an extent of relatedness between pairs of endpoints in a network, according to an embodiment of the invention. In one embodiment, the computer system 24 performs the technique relative to event data that has been recorded over some period of time, or that is currently being recorded or observed. Thus, in one embodiment, the technique discussed below can be performed in real-time, as the events relative to which the technique is performed are occurring. Under circumstances in which the events are e-mail transactions, such event data can be acquired from logs obtained from an e-mail server. In one embodiment, each event in the event data is a tuple that possesses at least the following attributes: a source, a destination, and a time. For example, if an event corresponds to a message transaction, then the source might be a source endpoint at which a message originated, the destination might be a destination endpoint to which that message ultimately was to be delivered, and the time might be the time at which the source endpoint sent the message.

In block 302, an initial bucket width, a number of windows, and a snap width are chosen. In block 304, an empty list of buckets is created. In block 306, a value of negative one is assigned to a previous bucket's value. In block 308, a topology is defined. In block 310, a flow tuple, indicating a source, destination, and time, is accepted.

In block 312, a determination is made whether a graph contains an edge from the tuple-indicated source to the tuple-indicated destination. If so, then control passes to block 314. Otherwise, control passes to block 316.

In block 314, an edge from the tuple-indicated source to the tuple-indicated destination is created in the graph. Control passes to block 316.

In block 316, a weight of the edge is incremented. In block 318, the tuple indicated time is converted into a bucket. In block 320, a determination is made whether the current bucket's value differs from the previous bucket's value. If so, then control passes to block 322. Otherwise, control passes to block 340.

In block 322, a new bucket is created. In block 324, the bucket is added to the bucket list. In block 326, the current bucket is set to be the newly created bucket. In block 328, a determination is made whether the first bucket in the list is beyond the window. If so, then control passes to block 330. Otherwise, control passes to block 340.

In block 330, a determination is made whether each tuple has been seen. If so, control passes back to block 328. Otherwise, control passes to block 332.

In block 332, a flow tuple, indicating a source, destination, and time, is accepted. In block 334, in the graph, a weight of an edge from the source to the destination is decremented. In block 336, a determination is made whether the edge's weight is zero or less. If so, then control passes to block 338. Otherwise, control passes back to block 332.

In block 338, the weight of the edge is decremented. Control passes back to block 328.

Alternatively, in block 340, the tuple is added to the current bucket. In block 342, a determination is made whether the bucket minus a value of a last bucket variable is greater than or equal to the snap width chosen in block 302. If so, then control passes to block 344. Otherwise, control passes back to block 310.

In block 344, a graph is built from a current edge list. In block 346, a [0, 1] normalization is performed on the edge weights with regard to an outflow of the source and the total destinations. In block 348, a topology of the built graph is shown. In block 350, the topology extracts all matching paths through the graph. In block 352, for each extracted path, topology relationships are recorded. Control passes back to block 310.

### Hardware Overview

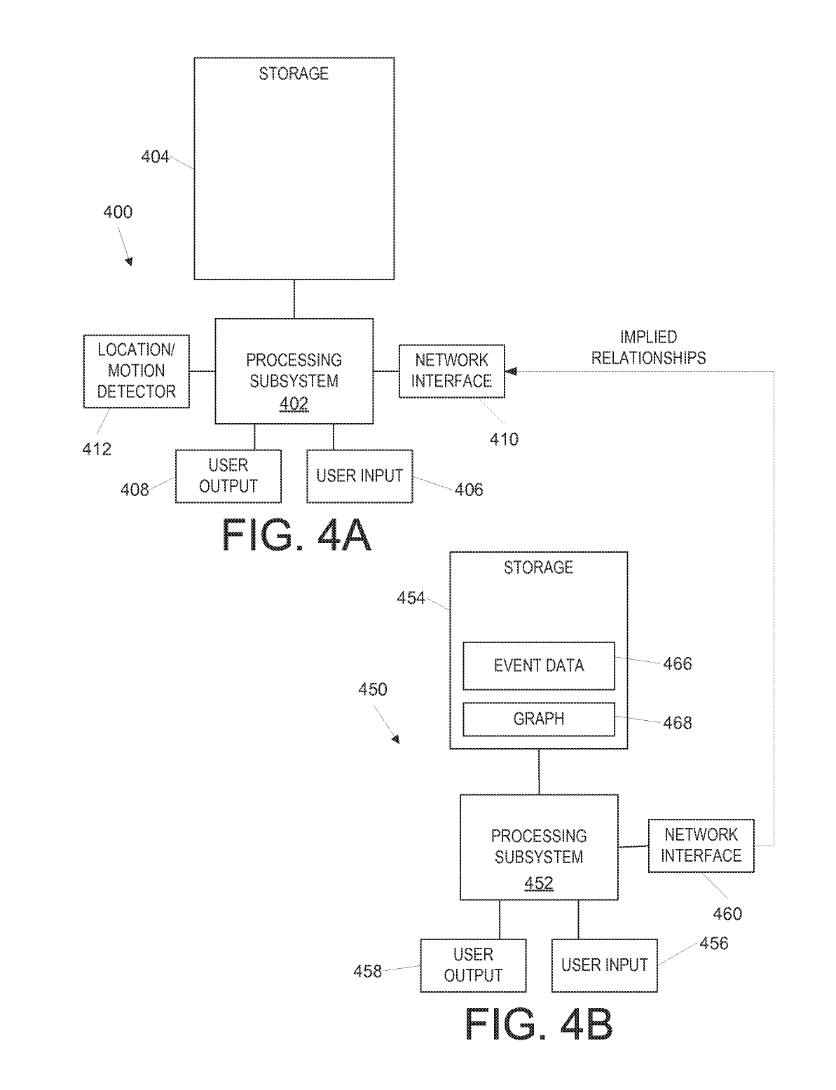

As an alternative to the embodiment of FIG. 5, FIG. 4A illustrates a simplified block diagram of an implementation of a device 400 according to an embodiment of the present invention. Device 400 can be a mobile device, a handheld device, a notebook computer, a desktop computer, or any suitable electronic device with a screen for displaying images and that is capable of communicating with a server 450 as described herein. Device 400 includes a processing subsystem 402, a storage subsystem 404, a user input device 406, a user output device 408, a network interface 410, and a location/motion detector 412.

Processing subsystem 402, which can be implemented as one or more integrated circuits (e.g., e.g., one or more single-core or multi-core microprocessors or microcontrollers), can control the operation of device 400. In various embodiments, processing subsystem 402 can execute a variety of programs in response to program code and can maintain multiple concurrently executing programs or processes. At any given time, some or all of the program code to be executed can be resident in processing subsystem 402 and/or in storage subsystem 404.

Through suitable programming, processing subsystem 402 can provide various functionality for device 400. For example, processing subsystem 402 can execute application programs (or “apps”).

Storage subsystem 404 can be implemented, e.g., using disk, flash memory, or any other storage media in any combination, and can include volatile and/or non-volatile storage as desired. In some embodiments, storage subsystem 404 can store one or more application programs to be executed by processing subsystem 402. In some embodiments, storage subsystem 404 can store other data. Programs and/or data can be stored in non-volatile storage and copied in whole or in part to volatile working memory during program execution.

A user interface can be provided by one or more user input devices 406 and one or more user output devices 408. User input devices 406 can include a touch pad, touch screen, scroll wheel, click wheel, dial, button, switch, keypad, microphone, or the like. User output devices 408 can include a video screen, indicator lights, speakers, headphone jacks, or the like, together with supporting electronics (e.g., digital to analog or analog to digital converters, signal processors, or the like). A user/customer can operate input devices 406 to invoke the functionality of device 400 and can view and/or hear output from device 400 via output devices 408.

Network interface 410 can provide voice and/or data communication capability for device 400. For example, network interface 410 can provide device 400 with the capability of communicating with server 450. In some embodiments network interface 410 can include radio frequency (RF) transceiver components for accessing wireless voice and/or data networks (e.g., using cellular telephone technology, advanced data network technology such as 4G, 4G or EDGE, WiFi (IEEE 402.11 family standards, or other mobile communication technologies, or any combination thereof), and/or other components. In some embodiments, network interface 410 can provide wired network connectivity (e.g., Ethernet) in addition to or instead of a wireless interface. Network interface 410 can be implemented using a combination of hardware (e.g., antennas, modulators/demodulators, encoders/decoders, and other analog and/or digital signal processing circuits) and software components.

Location/motion detector 412 can detect a past, current or future location of device 400 and/or a past, current or future motion of device 400. For example, location/motion detector 412 can detect a velocity or acceleration of mobile electronic device 400. Location/motion detector 412 can comprise a Global Positioning Satellite (GPS) receiver and/or an accelerometer. In some instances, processing subsystem 402 determines a motion characteristic of device 400 (e.g., velocity) based on data collected by location/motion detector 412. For example, a velocity can be estimated by determining a distance between two detected locations and dividing the distance by a time difference between the detections.

FIG. 4B is a simplified block diagram of an implementation of server 450 according to an embodiment of the present invention. Server 450 includes a processing subsystem 452, storage subsystem 454, a user input device 456, a user output device 458, and a network interface 460. Network interface 460 can have similar or identical features as network interface 410 of device 400 described above.

Processing subsystem 452, which can be implemented as one or more integrated circuits (e.g., a conventional microprocessor or microcontroller), can control the operation of server 450. In various embodiments, processing subsystem 452 can execute a variety of programs in response to program code and can maintain multiple concurrently executing programs or processes. At any given time, some or all of the program code to be executed can be resident in processing subsystem 452 and/or in storage subsystem 454.

Through suitable programming, processing subsystem 452 can provide various functionality for server 450. Thus, server 450 can interact with applications being executed on device 400 in order to provide implied relationships, or identities of pairs of endpoints involved in implied relationships with each other, to device 400. In one embodiment, server 450 stores event data 466 and generates graph 468 based on event data 466.

Storage subsystem 454 can be implemented, e.g., using disk, flash memory, or any other storage media in any combination, and can include volatile and/or non-volatile storage as desired. In some embodiments, storage subsystem 454 can store one or more application programs to be executed by processing subsystem 452. In some embodiments, storage subsystem 454 can store other data. Programs and/or data can be stored in non-volatile storage and copied in whole or in part to volatile working memory during program execution.

A user interface can be provided by one or more user input devices 456 and one or more user output devices 458. User input and output devices 456 and 458 can be similar or identical to user input and output devices 406 and 408 of device 400 described above. In some instances, user input and output devices 456 and 458 are configured to allow a programmer to interact with server 450. In some instances, server 450 can be implemented at a server farm, and the user interface need not be local to the servers.

It will be appreciated that device 400 and server 450 described herein are illustrative and that variations and modifications are possible. A device can be implemented as a mobile electronic device and can have other capabilities not specifically described herein (e.g., telephonic capabilities, power management, accessory connectivity, etc.). In a system with multiple devices 400 and/or multiple servers 450, different devices 400 and/or servers 450 can have different sets of capabilities; the various devices 400 and/or servers 450 can be but need not be similar or identical to each other.

Further, while device 400 and server 450 are described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Additionally, while device 400 and server 450 are described as singular entities, it is to be understood that each can include multiple coupled entities. For example, server 450 can include, a server, a set of coupled servers, a computer and/or a set of coupled computers.

Any of the computer systems mentioned herein may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components.

The subsystems can be interconnected via a system bus. Additional subsystems can be a printer, keyboard, fixed disk, monitor, which can be coupled to display adapter. Peripherals and input/output (I/O) devices, which couple to an I/O controller, can be connected to the computer system by any number of means known in the art, such as serial port. For example, serial port or external interface (e.g. Ethernet, Wi-Fi, etc.) can be used to connect computer system to a wide area network such as the Internet, a mouse input device, or a scanner. The interconnection via the system bus can allow the central processor to communicate with each subsystem and to control the execution of instructions from system memory or the fixed disk, as well as the exchange of information between subsystems. The system memory and/or the fixed disk may embody a computer readable medium. Any of the values mentioned herein can be output from one component to another component and can be output to the user.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

Any of the methods described herein may be totally or partially performed with a computer system including one or more processors that can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects

The descriptions of exemplary embodiments of the invention herein have been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

### GLOSSARY

As used herein, the terms below have the following definitions:

Graph: a collection of nodes and edges.

Node: a point or vertex in a graph. A node can represent an endpoint.

Edge: a direct link or connection between two nodes in a graph.

Co-temporal: occurring temporally together within a same specified temporal window.

Endpoint: a computer system connected to a network. Each endpoint has a unique identifier, such as an Internet Protocol address.

Shared endpoint: an endpoint with which each of two or more other endpoints have communicated at least once during a time interval.

Topology: a directed, acyclic proper sub-graph.

Popularity: a measure of how many other endpoints communicated with a particular endpoint during a time interval. Popularity is measured based on a quantity of communicators rather than a quantity of communications, such that multiple communications from the same endpoint will not increase a particular endpoint's popularity.

Weight: a measure of significance associated with something in a graph, such as an edge.

Network: a system of interconnected endpoints or interconnected computing devices. The Internet is an example of a network.

Bucket: a data structure having a unique identifier and an associated time range, capable of containing zero or more events.

Event: an activity occurring at a definite time and involving participants. The transmission of an e-mail message is an example of an event. In that example, the participants include a source (sender) and a destination (recipient).

Processor: a central processing unit of a computing device, or a processing core within such a central processing unit containing multiple processing cores. A processor is hardware, unlike a process, which a processor executes.

What is claimed is:

1. A computer-implemented method comprising:
determining via a communication link with a network a first set of endpoints with which a first endpoint has communicated over the network during a first time interval;
determining via the communication link a second set of endpoints with which a second endpoint has communicated over the network during the first time interval;
determining, based on an intersection between the first set of endpoints and the second set of endpoints, an extent of relatedness between the first endpoint and the second endpoint;
storing an indication of the extent of relatedness on a computer-readable medium; and
reporting the indication to a human user via an output component.

2. The computer-implemented method of claim 1, further comprising:
designating shared endpoints between first endpoints of the first set of endpoints and second endpoints of the second set of endpoints, the shared endpoints being located at an intersection between paired first endpoints and second endpoints;
assigning a separate node weight to each shared endpoint in the intersection; and
determining the extent of relatedness between the first endpoint and the second endpoint based on the node weights assigned to the shared endpoints in the intersection.

3. The computer-implemented method of claim 1, further comprising:
assigning a separate node weight to each shared endpoint in the intersection; and
determining the extent of relatedness between the first endpoint and the second endpoint by multiplying the node weights assigned to the shared endpoints in the intersection.

4. The computer-implemented method of claim 1, further comprising:
for each particular shared endpoint in the intersection,
(a) determining a node weight for that particular shared endpoint based on a proportion of a network's other endpoints that communicated with that particular shared endpoint during the first time interval, and
(b) assigning, to that particular shared endpoint, the node weight determined for that particular shared endpoint; and
determining the extent of relatedness between the first endpoint and the second endpoint based on the node weights assigned to the shared endpoints in the intersection.

5. The computer-implemented method of claim 1, further comprising:
for each particular shared endpoint in the intersection,
(a) determining a popularity for that particular shared endpoint based on a proportion of a network's other endpoints that communicated with that particular shared endpoint during the first time interval,
(b) determining a node weight for that particular shared endpoint based on a reciprocal of the popularity determined for that particular shared endpoint, and
(c) assigning, to that particular shared endpoint, the node weight determined for that particular shared endpoint; and
determining the extent of relatedness between the first endpoint and the second endpoint based on the node weights assigned to the shared endpoints in the intersection.

6. The computer-implemented method of claim 1, wherein the extent of relatedness is a first extent of relatedness, and further comprising:
determining a third set of endpoints with which the first endpoint has communicated over the network during a second time interval following the first time interval, the third set differing from the first set;
determining a fourth set of endpoints with which the second endpoint has communicated over the network during the second time interval, the fourth set differing from the second set;
determining, based on an intersection between the third set of endpoints and the fourth set of endpoints, a second extent of relatedness between the first endpoint and the second endpoint; and
storing an indication of the second extent of relatedness on a computer-readable medium.

7. The computer-implemented method of claim 6, further comprising:
adding the first extent of relatedness to the second extent of relatedness to determine a total extent of relatedness between the first endpoint and the second endpoint; and
storing the total extent of relatedness on a computer-readable medium.

8. The computer-implemented method of claim 6, further comprising:
assigning a separate node weight pertaining to the first time interval to each shared endpoint in the intersection between the first set and the second set;
determining the first extent of relatedness between the first endpoint and the second endpoint based on the node weights pertaining to the first time interval;
assigning a separate node weight pertaining to the second time interval to each shared endpoint in the intersection between the third set and the fourth set; and
determining the second extent of relatedness between the first endpoint and the second endpoint based on the node weights pertaining to the second time interval;
wherein the node weights assigned to a particular shared endpoint that is included in both of the intersections differ for the first and second time intervals.

9. The computer-implemented method of claim 6, further comprising:
assigning, to a particular shared endpoint that is in both the intersection of the first and second sets and the intersection of the third and fourth sets, a first node weight that is based on a proportion of a network's other endpoints that communicated with the particular shared endpoint during the first time interval;
determining the first extent of relatedness between the first endpoint and the second endpoint based at least in part on the first node weight assigned to the particular shared endpoint;
assigning, to the particular shared endpoint, a second node weight that is based on a proportion of the network's other endpoints that communicated with the particular shared endpoint during the second time interval; and
determining the second extent of relatedness between the first endpoint and the second endpoint based at least in part on the second node weight assigned to the particular shared endpoint;
wherein the proportion of the network's other endpoints that communicated with the particular shared endpoint during the first time interval differs from the proportion of the network's other endpoints that communicated with the particular shared endpoint during the second time interval.

10. The computer-implemented method of claim 1, further comprising:
determining a third set of endpoints with which a third endpoint has communicated over the network during the first time interval;
determining, based on a further intersection between the first set of endpoints and the third set of endpoints, an extent of relatedness between the first endpoint and the third endpoint;
determining, based on an intersection between the second set of endpoints and the third set of endpoints, an extent of relatedness between the second endpoint and the third endpoint;
storing an indication of the extent of relatedness between the first and third endpoints on a computer-readable medium; and
storing an indication of the extent of relatedness between the first and third endpoints on a computer-readable medium;
wherein the first, second, and third sets of endpoints differ from each other.

11. A non-transitory computer-readable storage medium storing instructions which, when executed by one or more processors, cause the one or more processors to:
determine a first set of endpoints with which a first endpoint has communicated over a network during a first time interval;
determine a second set of endpoints with which a second endpoint has communicated over the network during the first time interval;
determine, based on an intersection between the first set of endpoints and the second set of endpoints, an extent of relatedness between the first endpoint and the second endpoint; and
store an indication of the extent of relatedness on a computer-readable medium.

12. The non-transitory computer-readable storage medium of claim 11,
wherein the instructions, when executed by the one or more processors, cause the one or more processors to:
assign a separate node weight to each shared endpoint in the intersection; and
determine the extent of relatedness between the first endpoint and the second endpoint based on the node weights assigned to the shared endpoints in the intersection.

13. The non-transitory computer-readable storage medium of claim 11, wherein the instructions, when executed by the one or more processors, cause the one or more processors to:
assign a separate node weight to each shared endpoint in the intersection; and
determine the extent of relatedness between the first endpoint and the second endpoint by multiplying the node weights assigned to the shared endpoints in the intersection.

14. The non-transitory computer-readable storage medium of claim 11, wherein the instructions, when executed by the one or more processors, cause the one or more processors to:
for each particular shared endpoint in the intersection, (a) determine a node weight for that particular shared endpoint based on a proportion of a network's other endpoints that communicated with that particular shared endpoint during the first time interval, and (b) assign, to that particular shared endpoint, the node weight determined for that particular shared endpoint; and
determine the extent of relatedness between the first endpoint and the second endpoint based on the node weights assigned to the shared endpoints in the intersection.

15. The non-transitory computer-readable storage medium of claim 11, wherein the instructions, when executed by the one or more processors, cause the one or more processors to:
for each particular shared endpoint in the intersection, (a) determine a popularity for that particular shared endpoint based on a proportion of a network's other endpoints that communicated with that particular shared endpoint during the first time interval, (b) determine a node weight for that particular shared endpoint based on a reciprocal of the popularity determined for that particular shared endpoint, and (c) assign, to that particular shared endpoint, the node weight determined for that particular shared endpoint; and
determine the extent of relatedness between the first endpoint and the second endpoint based on the node weights assigned to the shared endpoints in the intersection.

16. The non-transitory computer-readable storage medium of claim 11, wherein the instructions, when executed by the one or more processors, cause the one or more processors to:
determine a third set of endpoints with which the first endpoint has communicated over the network during a second time interval following the first time interval, the third set differing from the first set;
determine a fourth set of endpoints with which the second endpoint has communicated over the network during the second time interval, the fourth set differing from the second set;
determine, based on an intersection between the third set of endpoints and the fourth set of endpoints, a second extent of relatedness between the first endpoint and the second endpoint; and
store an indication of the second extent of relatedness on a computer-readable medium.

17. The non-transitory computer-readable storage medium of claim 16, wherein the instructions, when executed by the one or more processors, cause the one or more processors to:
add the first extent of relatedness to the second extent of relatedness to determine a total extent of relatedness between the first endpoint and the second endpoint; and
store the total extent of relatedness on a computer-readable medium.

18. The non-transitory computer-readable storage medium of claim 16, wherein the instructions, when executed by the one or more processors, cause the one or more processors to:
assign a separate node weight pertaining to the first time interval to each shared endpoint in the intersection between the first set and the second set;
determine the first extent of relatedness between the first endpoint and the second endpoint based on the node weights pertaining to the first time interval;
assign a separate node weight pertaining to the second time interval to each shared endpoint in the intersection between the third set and the fourth set; and
determine the second extent of relatedness between the first endpoint and the second endpoint based on the node weights pertaining to the second time interval;
wherein the node weights assigned to a particular shared endpoint that is included in both of the intersections differ for the first and second time intervals.

19. The non-transitory computer-readable storage medium of claim 16, wherein the instructions, when executed by the one or more processors, cause the one or more processors to:
assign, to a particular shared endpoint that is in both the intersection of the first and second sets and the intersection of the third and fourth sets, a first node weight that is based on a proportion of a network's other endpoints that communicated with the particular shared endpoint during the first time interval;
determine the first extent of relatedness between the first endpoint and the second endpoint based at least in part on the first node weight assigned to the particular shared endpoint;
assign, to the particular shared endpoint, a second node weight that is based on a proportion of the network's other endpoints that communicated with the particular shared endpoint during the second time interval; and
determine the second extent of relatedness between the first endpoint and the second endpoint based at least in part on the second node weight assigned to the particular shared endpoint;
wherein the proportion of the network's other endpoints that communicated with the particular shared endpoint during the first time interval differs from the proportion of the network's other endpoints that communicated with the particular shared endpoint during the second time interval.

20. The non-transitory computer-readable storage medium of claim 11, wherein the instructions, when executed by the one or more processors, cause the one or more processors to:
determine a third set of endpoints with which a third endpoint has communicated over the network during the first time interval;
determine, based on an intersection between the first set of endpoints and the third set of endpoints, an extent of relatedness between the first endpoint and the third endpoint;
determine, based on an intersection between the second set of endpoints and the third set of endpoints, an extent of relatedness between the second endpoint and the third endpoint;
store an indication of the extent of relatedness between the first and third endpoints on a computer-readable medium; and
store an indication of the extent of relatedness between the first and third endpoints on a computer-readable medium;
wherein the first, second, and third sets of endpoints differ from each other.

21. A computer-implemented method comprising:
monitoring activity via a computer coupled to a communication network;
generating a first ranked list of other endpoints with which a first endpoint has communicated via the communication network during a time interval;
generating a second ranked list of other endpoints with which a second endpoint has communicated during the time interval;
determining a similarity of the first ranked list to the second ranked list;
determining an extent of relatedness of the first endpoint to the second endpoint based on the similarity;
storing an indication of the extent of relatedness on a computer-readable medium; and
outputting via an output device a report on extent of relatedness among selected endpoints.

22. The computer-implemented method of claim 21, further comprising:
determining proportions of total communications of the first endpoint that involved each of the other endpoints during the time interval;
ranking the other endpoints based on the proportions of total communications of the first endpoint that involved the other endpoints during the time interval to generate the first ranked list;
determining proportions of total communications of the second endpoint that involved each of the other endpoints during the time interval; and
ranking the other endpoints based on the proportions of total communications of the second endpoint that involved the other endpoints during the time interval to generate the second ranked list.

23. A non-transitory computer-readable storage medium storing instructions which, when executed by one or more processors, cause the one or more processors to:
generate a first ranked list of other endpoints with which a first endpoint has communicated via a communication network during a time interval;
generate a second ranked list of other endpoints with which a second endpoint has communicated during the time interval;
determine a similarity of the first ranked list to the second ranked list;
determine an extent of relatedness of the first endpoint to the second endpoint based on the similarity; and
store an indication of the extent of relatedness on a computer-readable medium.

24. The non-transitory computer-readable storage medium of claim 23, wherein the instructions, when executed by the one or more processors, cause the one or more processors to:
determine proportions of total communications of the first endpoint that involved each of the other endpoints during the time interval;
rank the other endpoints based on the proportions of total communications of the first endpoint that involved the other endpoints during the time interval to generate the first ranked list;
determine proportions of total communications of the second endpoint that involved each of the other endpoints during the time interval; and
rank the other endpoints based on the proportions of total communications of the second endpoint that involved the other endpoints during the time interval to generate the second ranked list.
